(19) United States
(12) Patent Application Publication
(10) Pub. No.: US 2026/0161531 A1
(43) Pub. Date: Jun. 11, 2026

(54) SYSTEM AND METHOD FOR AUTOMATED GENERATION AND EXECUTION OF TEST CASES

(71) Applicant: Do Nothing Corp., New York, NY (US)

(72) Inventors: Harrison KEEFE, New York, NY (US); Eli Shlonsky, Brooklyn, NY (US); Noah Borts, New York, NY (US); Ethan Blaze, New York, NY (US)

(21) Appl. No.: 19/179,199

(22) Filed: Apr. 15, 2025

Related U.S. Application Data
(60) Provisional application No. 63/634,675, filed on Apr. 16, 2024.

(51) Int. Cl. G06F 11/3668

(52) U.S. Cl. CPC G06F 11/3672

(57) ABSTRACT

A system and method are presented for automated generation and execution of test cases to evaluate the performance of an application or website. The system includes a DOM Decompiling Algorithm, a Conductor Agent Model, and a Pathfinder Model. The system decompiles the DOM, classifies interactable components of the DOM, generates a cleaned and semantically enhanced DOM, assesses potential interactions, executes the interactions and poses simple questions to users based on the interactions, and generates and executes a test script based on user responses. In some embodiments, the system regenerates the classified components in response to user non-approval to improve the efficiency and accuracy of the generated and executed test cases.

### CROSS-REFERENCE TO RELATED APPLICATIONS

This application is a non-provisional application of, claims benefit of, and priority under 35 U.S.C. § 119(e) to, co-pending and commonly owned U.S. Provisional Patent Application Ser. No. 63/634,675, filed on Apr. 16, 2024, titled “System and Method for Automated Generation And Execution Of Test Cases,” which is hereby incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent files or records, but otherwise reserves all copyright rights whatsoever.

### BACKGROUND OF THE INVENTION

### 1. Technical Field

The present disclosure relates generally to systems and methods for an automated generation and execution of test cases to evaluate functionality of computer-implemented software applications and/or websites. More particularly, the present disclosure relates to systems and methods for analyzing and classifying components of a software application and/or a website to generate and to execute test cases to evaluate the functionality of the components and the application and/or webpage employing the components. In some embodiments discussed herein, one, more, or all of analyzing, classifying, generating, and executing steps of the test generation and execution systems and methods may include interacting with a large language model (LLM).

### 2. Related Art

Testing the functionality of software applications and websites is an important part of the development process. Traditionally, evaluation testing was developed manually by application developers and planned users of such applications. More recently, efforts have been made to provide tools to automate such testing in whole or in part. Further improvements to such automation efforts are needed.

As is generally known, Artificial intelligence (AI) and Deep Learning (DL) using large language models (LLMs) provide improvements to many automated tasks. LLMs are very large DL models that include a relatively large number of parameters (e.g., millions or billions) that are trained to generate explanations to input queries.

Accordingly, the inventors have discovered that focusing LLMs and their power to generate explanations from input quires may be utilized to improve automation of evaluation testing of components of software applications and/or websites.

### SUMMARY

The present disclosure is directed to systems and methods for an automated generation and execution of test cases to evaluate performance of at least one of a computer-implemented software application or a website. In one embodiment, the system includes a processor and a memory operatively coupled to the processor and storing instructions. When the instructions are executed by the processor, the system is caused to receive a document object model (DOM) of the at least one the computer-implemented software application or the website, identify interactable elements within the DOM, and classify the identified elements into one or more components. In one embodiment, the instructions are further executed to identify workflows and actions to determine potential interactions with a user for completing tasks associated with the classified one or more components. The identified workflows and actions are executed by the system to generate first questions to guide the potential interactions between the user and each of the classified one or more components. The system then receives responses to the first questions.

In one embodiment, in response to the received responses, the instructions are further executed to cause the system to recursively assess the received responses to the first questions generated from the executed workflows and actions for the potential interactions for each of the one or more components and to determine acceptability of the received responses. When the received responses are determined to be incorrect, the instructions cause the system to regenerate the first questions, the workflows and the actions to guide next potential interactions for each of the classified one or more components. The re-generated workflows and actions are then re-executed. In one embodiment, when the received responses for each of the one or more components are determined to be correct, the instructions cause the system to assign the first questions, the workflows, and the actions determined to be correct to a corresponding one of the one or more components, where the assigned first questions are defined as simple questions. The instructions further cause the system to execute the assigned workflows and actions as interactions of the user with the one or more components and to prompt the user with the simple questions and to request the user approve the executed actions and input provided during execution.

In one embodiment, the system receives responses input by the user and the instructions further case the system to recursively assess the received user responses to each of the executed actions for the one or more components. In one embodiment, when a response is indicative of a user determined unacceptable interaction, the instructions further cause the system to regenerate the identified workflows, actions, and simple questions to guide a next interaction with each of the classified one or more components and to present the regenerated simple questions to the user and receive the responses input by the user. In one embodiment, when the response is indicative of a user determined acceptable interaction, the instructions further cause the system to assign the identified workflows, actions, and simple questions for evaluating the performance of the classified one or more components. In one embodiment, when all the classified one or more components are assessed, the instructions further cause the system to store the assigned workflows, actions, and simple questions for each of the classified one or more components as a test case for evaluating the functionality of the at least one computer-implemented software application or the website including the one or more components.

In one embodiment, prior to identifying the interactable elements within the DOM, the instructions further cause the system to determine test objectives and performance metrics for the at least one of the computer-implemented software application or the website being evaluated. In one embodiment, the test objectives include pretext information and context information. In one embodiment, the pretext information defines a purpose of functionality within the at least one of the computer-implemented software application or the website being evaluated. In one embodiment, the pretext information further includes a persona for presenting the simple questions to the user. In one embodiment, the context information defines a background of the functionality within the at least one of the computer-implemented software application or the website being evaluated.

In one embodiment, the instructions to identify the interactable elements within the DOM further include instructions that, when executed by the processor, cause the system to decompile the DOM into elements thereof, to evaluate the elements of the decompiled DOM, to identify useful elements and un-useful elements within the decompiled DOM, where the useful elements include the interactable elements, and to generate a cleaned DOM by removing the un-useful elements and maintaining the useful elements of the decompiled DOM. In one embodiment, the un-useful elements are static elements within the DOM and the interactable elements are elements of the DOM including at least one of executable functionality or a link to another element or other content of the DOM. In one embodiment, prior to the instructions to cause the system to generate the cleaned DOM, the instructions further cause the system to augment the useful elements with listener data to detect an impact of functionality of the useful elements to further identify interactable elements within the useful elements.

In one embodiment, the instructions to classify the identified elements include instructions that, when executed by the processor, cause the system to classify the identified elements as the one or more components based on a classification model, and to generate a modified DOM including the classified and semantically enhanced one or more components. In one embodiment, the instructions to classify the identified elements further include instructions that, when executed by the processor, cause the system to assign the one or more components into buckets based upon predetermined rules and associated workflows for the one or more components, where two or more components of a same type are assigned to a same bucket.

In one embodiment, the instructions to identify workflows and action further include instructions that, when executed by the processor, cause the system to retrieve the workflows from a library of workflows associated with a type of the component. In one embodiment, the instructions to recursively assess the potential interactions for each of the one or more components further include instructions that, when executed by the processor, cause the system to interact with a large language model (LLM) to at least one of determine whether the received responses are correct or to determine the re-generated workflows and actions to be executed. In one embodiment, the instructions to interact with the LLM to determine the re-generated workflows and actions further include instructions to determine statistically by utilizing an inference capability of the LLM, the interaction for a classification of the one or more components to define the re-generated workflows and actions. In one embodiment, the instructions to assign the questions, the workflows and the actions are determined to be correct further include instructions to generate an updated DOM including the assigned workflows, the actions, and the questions for each of the corresponding ones of the one or more components.

In one embodiment, the instructions to prompt the user to approve the executed actions further include instructions that, when executed by the processor, cause the system to generate a natural language prompt for the LLM to present to the user as a prompt to elicit the response from the user. In one embodiment, the instructions to regenerate the identified simple questions, the workflows, and the actions further include instructions that, when executed by the processor, cause the system to generate a regenerated DOM including the assigned workflows, the actions, and the simple questions for each of the corresponding ones of the one or more components.

### BRIEF DESCRIPTION OF THE DRAWINGS

Referring now to the Figures, which are exemplary embodiments, and wherein like elements are numbered alike.

FIG. 1 is a simplified, schematic diagram of an automated test generation system, in accordance with one embodiment.

FIGS. 2A to 2D depict a flow diagram of a process employed with the generation system of FIG. 1 for developing an automated testing of functionality of a website or application, in accordance with one embodiment.

FIG. 3 is a block diagram illustrating a conventional method for parsing of a file into a document object model and rendering the document object model into a webpage.

FIG. 4 is a table depicting input and output of steps and tools employed to implement the process of FIG. 1, in accordance with one embodiment.

### DETAILED DESCRIPTION OF EXEMPLARY EMBODIMENTS

### Overview of System Architecture

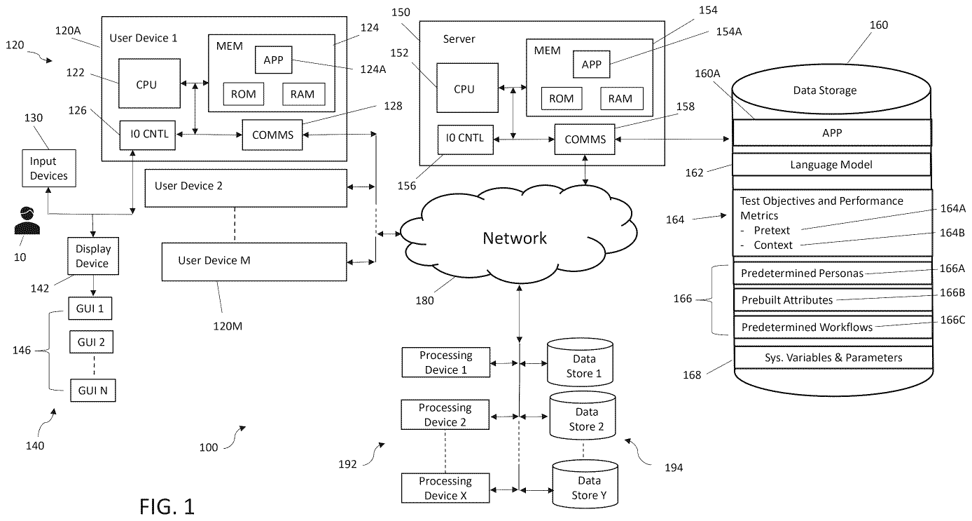

FIG. 1 depicts a simplified block diagram view of a client-server architecture employing an automated test generation and execution system 100, in accordance with some exemplary embodiments of the present disclosure. As described herein, the test generation and execution system 100 employs methods to generate and execute test cases to evaluate functionality of computer-implemented software applications and/or websites. For example, the methods of the system 100 analyze and classify components of a software application and/or a website and generate and execute test cases to evaluate the functionality of the classified components and the application and/or webpage employing the components. In some embodiments, one, more, or all of analyzing, classifying, generating, and executing steps of the test generation and execution systems and methods may include interacting with a large language model (LLM).

As shown in FIG. 1, the system 100 includes a plurality of client or user devices, shown generally at 120, including user devices 120A to 120M, operatively coupled to and in communication with a network 180. In one embodiment, each of the user devices 120 includes or is operatively coupled via the network 180 to one or more processors (CPU) 122 or processing devices 192, memory (e.g., internal memory (MEM) 124 including hard drives, ROM, RAM, and the like), and/or data storage devices 194 (e.g., hard drives, optical storage devices, and the like) as is known in the art. In one embodiment, each of the user devices 120 includes or is operatively coupled to one or more input devices 130 and one or more output devices 140 via an input/output controller (IO CNTL) 126. In one embodiment, the input devices 130 may include, for example, a keyboard, mouse, stylus, or like pointing device, buttons, wheels, touch pad, or touch screen portions of a display device, or input ports for receiving and providing data and information to the user device 120. In one embodiment, the output devices 140 include, for example, one or more display devices 142 integral with or operatively coupled to the user device 120 to exhibit visual output, a speaker (not shown) to provide audio output, a printer (not shown) to provide printed output, and/or output ports (not shown) for outputting data and information from the user device 120. In one embodiment, the visual and printed output includes documents, images, and other visual representations of data and information from the system 100. In one embodiment, the display devices 142 exhibit one or more graphical user interfaces (GUIs) 146 (as described below) that may be visually perceived by a user/operator 10 operating one of the user devices 120. It should also be appreciated that for clarity purposes, components (e.g., CPU, MEM, IO CNTL, input and output devices, and the like) are depicted in FIG. 1 only with reference to User Device 1 but equally may correspond to one or more of the other user devices (User Device 2 to User Device M). In one embodiment, the user devices 120 include, for example, a personal computer or workstation, or portable computer processing devices such as, for example, a personal digital assistant (PDA), iPAD™ device, tablet, laptop, mobile radio telephone, smartphone (e.g., Apple™ iPhone™ device, Google™ Android™ device, etc.), or the like. It should be appreciated that the designations Apple, iPhone, and iPad are trademarks of Apple Inc. of Cupertino, California. It should also be appreciated that the designations Google and Android are trademarks of Google LLC of Mountain View, California.

In one embodiment, the test generation and execution system 100 and each of the user devices 120 may be operatively coupled to and in communication with, via the network 180, a server 150. In one embodiment, the server 150 includes one or more processors (CPU) 152, memory (e.g., internal memory (MEM) 154 including hard drives, ROM, RAM, and the like), an input/output controller (IO CNTL) 156 for receiving and outputting data and information via input and output devices coupled thereto (not shown), and/or one or more data storage devices 160 (e.g., hard drives, optical storage devices, and the like) as is known in the art. In one embodiment, illustrated in FIG. 1, each of the user devices 120 and the server 150 include communication circuitry (COMMS) 128 and 158, respectively, such as a transceiver or network interface card (NIC), for operatively coupling the user devices 120 and the server 150 by wired or wireless communication connections to the network 180 such as, for example, a local area network (LAN), an intranet, extranet, or the Internet, and to a plurality of processing devices 192 (e.g., processing devices 1 to X) and/or a plurality of data storage devices 194 (e.g., data stores 1 to Y), also operatively coupled to and communicating with the network 180.

It should be appreciated that, while not shown, the network 180 may include, for example, cell towers, routers, repeaters, ports, switches, and/or other network components that comprise the Internet and/or a cellular telephone network and/or Public Switched Telephone Network (PSTN), as is known in the art. It should also be appreciated that the network 180 may include or utilize, for example, components and/or resources in a “cloud” or virtual environment. It should further be appreciated that communication and transfer of data between devices (e.g., user devices 120, the server 150, the one or more data storage devices 160, the plurality of processing devices 192, and/or the plurality of data storage devices 194) coupled to the network 180 may occur through protocols operating at various Open Systems Interconnection (OSI) model layers including, for example, Transmission Control Protocol/Internet Protocol (TCP/IP) on the Transport and Internet layers and/or the Hypertext Transfer Protocol (HTTP) and interfaces such as, for example, application programming interfaces (APIs) calls, as are known to those skilled in the relevant art. Still further, it should be appreciated that the system 100 may require user credentials (e.g., username and password) to access and execute functionality of the system 100.

In one embodiment as described herein, the user devices 120 and the server 150 cooperate to implement the test generation and execution system 100 that identifies interactable elements from a subject, computer-implemented software application and/or website, classifies and semantically enhances the identified elements into components (e.g., by assigning meaning and relationships to the identified elements) based on a classification model, identifies workflows for the classified components to determine potential interactions, generates simple questions and interacts with a language model to pose the simple questions to a user, recursively assesses the user responses, and as necessary or desired, regenerates the classified components to automatically build a test case to evaluate functionality of the subject application and/or website based on assigned interactions and user responses. In one aspect of the automated test generation system 100, the user devices 120 and the server 150 execute a plurality of programmable instructions of a multifunctional software application or app (e.g., “APP”) of the system 100, or portions or modules thereof, 124A, 154A, or 160A, stored in local memory 124, 154, or network memory 160, respectively, to implement the automated test generation system 100 and features and/or functions thereof. In one embodiment, users of the system 100 (e.g., the operators 10 operating the user devices 120) may be granted differing authorizations or permissions and/or levels thereof, to execute various ones of the features and/or functions of the system 100. For example, the authorizations or permissions may specify whether a user may be able to access and/or manipulate, e.g., perform operations upon, information stored within the system 100, as described herein.

In one embodiment, the APPs 124A, 154A, or 160A interact with a language model 162 stored in the data storage device 160 or accessed through communication with one or more of the plurality of processing devices 192 (e.g., processing devices 1 to X) and associated data storage devices 194 (e.g., data stores 1 to Y), which include the language model (not shown). As described herein, in one embodiment, the language model is a large language model (LLM). In one embodiment, the test case is built from input test objectives and performance metrics that are received or retrieved by the system 100 and stored in, for example, the data storage device 160, as shown generally at 164. As illustrated in FIG. 1 and described below, in one embodiment, the test objectives and performance metrics 164 may include a pretext 164A and context 164B of the subject application and/or website under evaluation. In one embodiment, the APPs 124A, 154A, and 160A utilize a plurality of predefined and/or predetermined evaluation variables stored in the data storage device 160, shown generally at 166. In various embodiments, described herein, the predetermined evaluation variables may include predetermined personas 166A, prebuilt attributes 166B for identified components, and/or predetermined workflows 166C including common interactions with identified components. In one embodiment, various variables and parameters, shown generally at 168, that are used by the system 100, are stored in the data storage device 160.

### Overview of System Processing

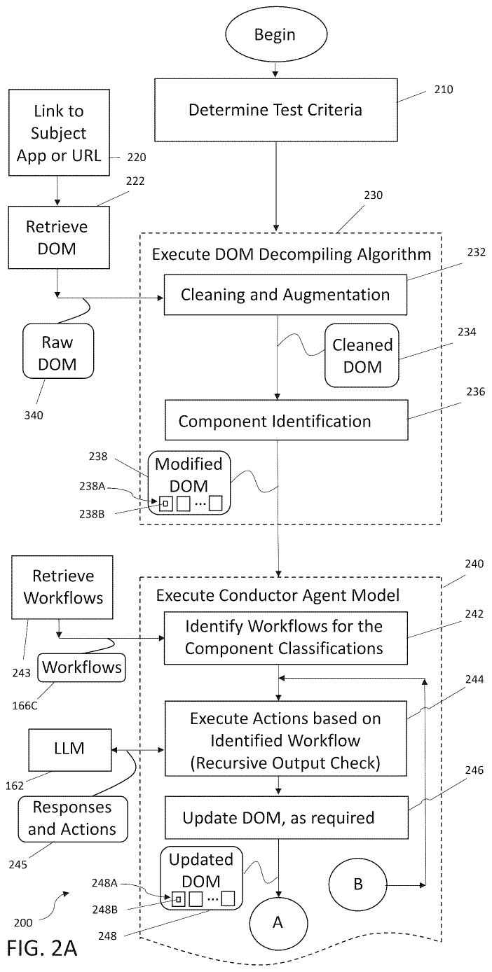

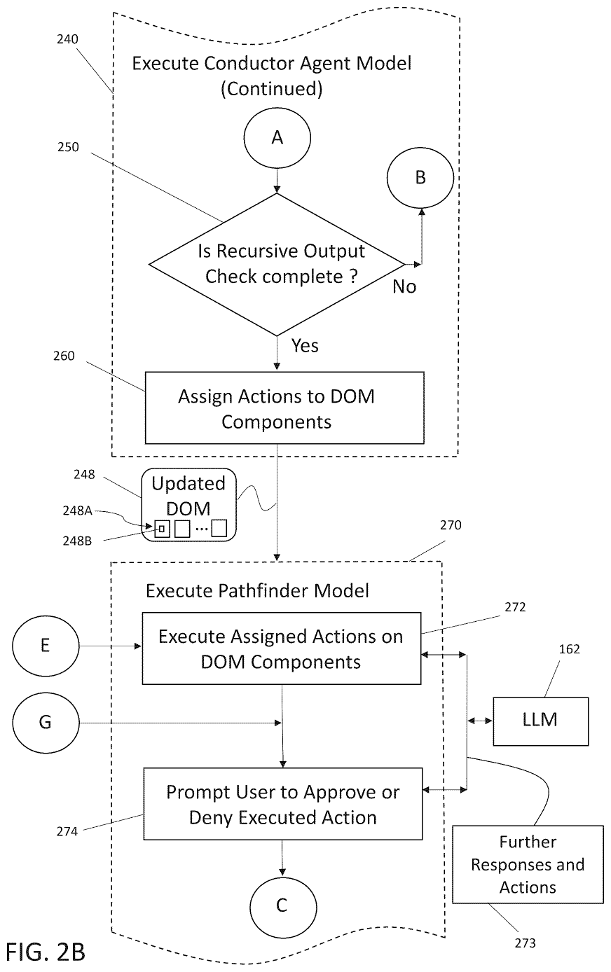

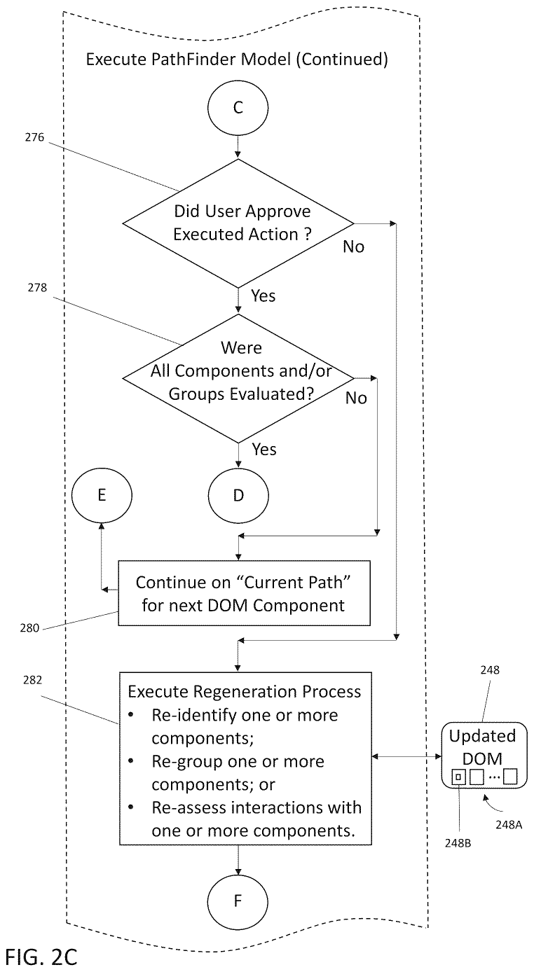

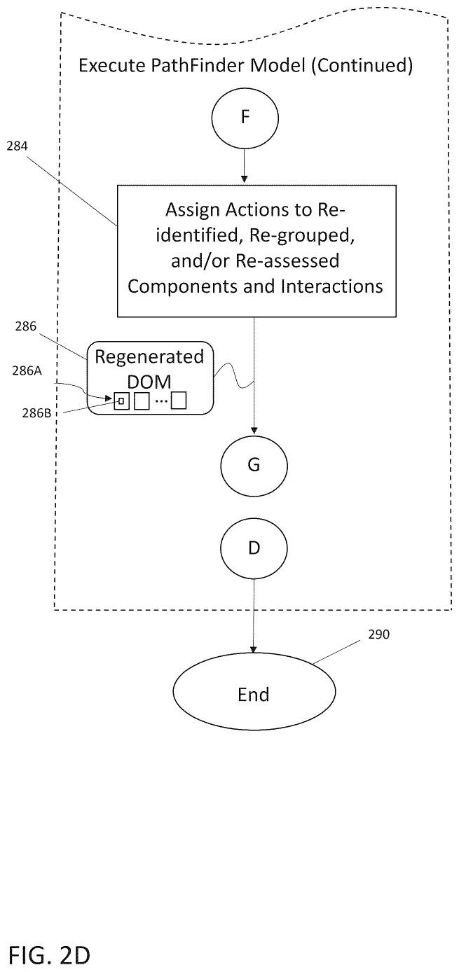

In one embodiment, the system 100 for automated generation and execution of test cases employs three (3) tools in a process 200, illustrated in FIGS. 2A to 2D. For example, in various embodiments, one or more of the APPs 124A, 154A, 160A executes the tools in implementing the test generation and execution system 100.

Initially, at Step 210, test criteria are determined for the functionality of the subject software application and/or website to be evaluated. In one embodiment, the test criteria include objectives of the subject application and/or website (e.g., intent of its operation) and criteria by which acceptable performance is weighted. In one embodiment, the objectives include, for example, a “pretext” and “context” of the testing. For example, as described herein, the pretext refers to a base understanding of the application and/or website including, for example, a purpose of the functionality within a business'goals such as one or more tasks to be accomplished using the software application and/or website. In one embodiment, the pretext may also include a “persona” of who is using the application and/or website. For example, if the system 100 is employed to evaluate the functionality of a loan creation application for a merchant bank, the pretext may include understanding that the test criteria is for a merchant bank utilizing an application or website to complete and process a loan application. In this exemplary case, the persona may be that of a loan officer working with an applicant to complete a loan application. Within the system 100 and methods of the present disclosure, this pretext and the base understanding interacts with an LLM by:
1. Isolating the LLM and its chain of logic and statistical output by confining the universe of what may be asked before generating the action to ask a question; and
2. Allowing the LLM to take on a determined persona to, for example, increase a statistical likelihood of a correct answer or action being taken, for example, within the system's knowledge of the pretext and base understanding of the subject application or website.

In one embodiment, the pretext is one of initial information determined for the test criteria being developed (at Step 210) and supplemented as the context of the testing is further developed, as described herein. In one embodiment, pretext may be determined as part of, for example, a process of onboarding a new client or user 10 of the system 100, prior to any test creation. During an exemplary onboarding process, information may be captured including, for example, a purpose of a company, applications within the company, and the personas that operate the applications. When received and/or determined, the pretext and/or context may be stored in the data storage device 160 as shown at 164A and 164B, respectively.

In one embodiment, the context 164B refers to the background of the test itself, for example, what functionality is to be evaluated on what software application or website. For example, the context 164B provides the test generation and execution system 100 (and the LLM 162) an understanding at a more granular level than the pretext 164A of what the test is trying to accomplish and, with the pairing of the pretext 164A and the context 164B, where the test is executed. In one embodiment described herein, a user (e.g., the user/operator 10 of one of the user devices 120 as illustrated in FIG. 1) is prompted by the system 100 to create a new test and in reply, the user 10 enters an anchor such as, for example, a base domain name (URL) for a website (Step 220) that is retrieved by the system 100 to access the subject software application or website to be evaluated (Step 222), the objective of the test, and then a selection of persona. In one embodiment, the persona may be selected from one or more predetermined personas 166A, as described herein. Once the context 164B is captured, the context and remaining portions of the test criteria as well as the anchor are provided to the system 100 to continue processing (Steps 210 and 222 continue to Step 230).

Beginning at Step 230, the test generation and execution system 100 executes the aforementioned three (3) tools including a Document Object Model (DOM) Decompiling Algorithm (Step 230), Conductor Agent Model (Step 240), and PathFinder Model (Step 270). As described herein, the DOM Decompiling Algorithm decompiles a DOM representing the subject software application and/or website, evaluates and identifies components within the application or website, provided or retrieved at Steps 220 and 222. In one embodiment, the DOM Decompiling Algorithm identifies components of the subject software application or webpage and categorizes them, e.g., into “buckets,” based upon predetermined rules such as, for example, type of functionality initiated by the components and associated workflows described below. For example, for a website, components may identify portions and/or functionality of the website including a header or footer, wrappers, clusters, navigation elements (e.g., menu or the like), content including images or text, which may be static or dynamic/interactable elements by including a link to other content (e.g., invoke navigation control to another page of the website), slider or scroll bar elements, and the like. It should be appreciated that the list of components is merely illustrative and not a limitation of the present disclosure as more or less functionality may be incorporated within the subject application or website.

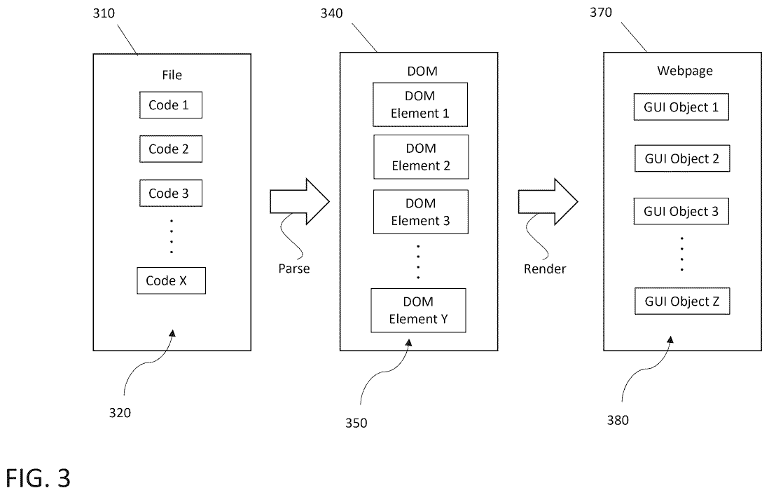

In one embodiment, with reference to FIG. 3, a file 310 includes program code (depicted as Code 1 to Code X, shown generally at 320) including, for example, HTML or JSON commands, defining functionality with the subject application or webpage. As is well known, the file 310 may be read by, for example, a web browser software (not shown), parsed to identify the code 320 included therein and to rendered visually on an operational website (e.g., one of GUI 1 to GUI N 146 on FIG. 1) exhibited to a user. For example, web browser software typically includes a parser or parsing operation that reads a file (e.g., file 310) and produces a DOM. As is well known, a DOM is a programming interface that includes a data representation of objects that comprise the structure and content of a document on the Internet and allows manipulation thereof. For example, a DOM represents the document as nodes and objects and permits programmatic modification to a structure, style, and content of the document and thus, the website resulting therefrom. As shown in FIG. 3, the file 310 is parsed to produce a DOM 340 including DOM elements, depicted as DOM Element 1 to DOM Element Y, shown generally at 350. The DOM 340 is processed by the web browser to render a webpage 370 including graphic objects, depicted as GUI Objects 1 to GUI Object Z, shown generally at 380.

Referring again to FIG. 2A, the DOM Decompiling Algorithm of Step 230 identifies components of the subject software application or webpage, “cleans” the DOM (e.g., DOM 340 also referred to as “Raw DOM” 340) to remove un-useful components (as described herein) and categorizes the remaining useful components into “buckets” based upon predetermined rules and associated workflows. At Step 240 the Conductor Agent Model is executed to assess the buckets created by the DOM Decompiling Algorithm and to determine and generate potential interactions (described herein), and then to leverage a library of workflows to systematically plan, criticize, and define a “best” series of potential interactions for completing tasks associated with identified components. In one embodiment, the Conductor Agent Model may generate, for any given bucket and/or component therein, “simple questions” (described herein) to be provided to the LLM 162, which is configured to use the output (e.g., the simple questions) within prompts by the LLM 162 to elicit a response from a user (e.g., elicit input from the user) and to further build and/or refine a test case for evaluating the software application or website. At Step 270, the PathFinder is executed to ask “simple questions,” execute the interactions, and recursively assess user responses to the executed interactions to, once again, further build and/or refine the test case for the software application or website being evaluated.

In one embodiment, the test generation and execution system 100 decompiles the DOM 340 (performed by the DOM Decompiling Algorithm at Step 230) and uses the determined pretext 164A and context 164B to formulate simple questions for the LLM 162. Once the system 100 “understands” the components of a subject application or webpage under evaluation, the LLM 162 is utilized to provide, for example, a sample set of potential responses. In one exemplary embodiment, for example, in a web-enabled user registration form, there is likely to be a “First Name” field (e.g., as one of the GUI Objects 380 of a subject webpage 370 rendered from DOM 340 (FIG. 3)). By determining that the First Name field is a text field and that the wrapper for the subject webpage identifies the First Name field through a term such as, for example, “first_name” a simple question can be posed to the LLM 162 of, for example, “Given this objective, provide a list of potential first names?”. This example simple question is often refined by the pretext 164A and the context 164B of a test, but in an exemplary manner, the above-described processing logic is followed. As described herein, needs or requirements for data input to various interactable components are classified into groups (e.g., buckets) based on the components and/or component types present in the software application or website under evaluation as a whole. The Conductor Agent Model then generates a suite of data (e.g., multiple values of data) that meets the data needs or requirements of the application or website and components thereof under evaluation, e.g., based on the functionality of the components, to maintain consistency and cohesiveness across the data suite. This process is repeated each time for each interactable element/component. In view of this exemplary process, it should be appreciated that the system 100 executes the aforementioned tools (e.g., the DOM Decompiling Algorithm (at Step 230), the Conductor Agent Model (at Step 240), and the PathFinder (at Step 270) to convert an input or Raw DOM 340 representing a software application or website under evaluation and components 350 identified therein into simple questions to present to the LLM 162 to formulate a test case for execution to evaluate the functionality of the software application or website and components thereof.

More specifically, at Step 230, the DOM Decompiling Algorithm performs cleaning and augmenting functions upon the provided or retrieved “raw” DOM (e.g., DOM 340) of the subject software application or website under evaluation, as the algorithm identifies and classifies the components 350 of DOM 340.

### Cleaning and Augmentation

In one embodiment, when cleaning and augmenting of the data of the DOM 340 the DOM Decompiling Algorithm executes steps (depicted as Steps 232 and 236 of FIG. 2A) of scanning the DOM 340 to determine useful and un-useful elements. In one embodiment, the cleaning and augmenting processes performed at Step 232 include a first operation of identifying and removing determined un-useful elements that include, for example, non-functionality such as borders, icons, and images without subtext or being linked to other content or actions, as may be the case with dynamic/interactable elements or components (e.g., useful elements or components, as described below). A second operation of Step 232 includes isolating all unknown elements (e.g., elements not determined to be either useful or un-useful elements in the first operation) and running the unknown elements through an algorithm to determine an impact, if any, the unknown element may have on functionality of the software application or website under evaluation. In one embodiment, the Decompiling Algorithm may include one or more steps to compress a page or window of the software application or website under evaluation to produce a more semantically dense version thereof. In one embodiment, steps of the Decompiling Algorithm may include a combination of custom attribute white/blacklists, traditional semantic assessment algorithms, cosine/dot product similarity functions on privately gathered datasets, and pairing of described/describing elements, in some embodiments, through a hybrid approach, e.g., utilizing different combinations depending upon components and/or functionality encountered. In one embodiment, the impact on functionality encountered may be determined by, for example, statically analyzing attributes of the unknown element. For example, if an element has an identifier (e.g., within the underlying code), then the identifier may be used to determine if the identifier is expressed in natural language (e.g., a human readable language such as English). In one embodiment, natural language identifier may be utilized to identify common or similar processing for an element (e.g., whether it is a non-interactable element such as a header or the like).

After the un-useful elements have been removed from the DOM 340, the DOM Decompiling Algorithm may, in some embodiments, add listener data to remaining elements (e.g., DOM Elements 350) to gather further information to aid an understanding of whether actions can be taken on any given element, exposing potentially obfuscated behaviors of the given useful element. This additional, and in some embodiments optional, action may allow the DOM Decompiling Algorithm an ability to rewrite attributes based on a prebuilt matrix of potential manners to write attributes (e.g., the prebuilt attributes 166B). For example, in pursuit of removing inconsequential components from the DOM 340, the DOM Decompiling Algorithm assesses the attributes of each element/component in relation to the type of element/component as well as its positioning and context within the software application or website under evaluation. Given these parameters, the DOM Decompiling Algorithm then removes, adds, and/or rewrites elements/components accordingly. In one embodiment, the manner for modifying the element/component's representation is determined by, for example, the prebuilt matrix of potential manners (e.g., the prebuilt attributes 166B). In one embodiment, this means that in circumstances where an input type is documented as, for example “text” or “txt”, the DOM Decompiling Algorithm can rewrite the DOM element as an input type=“text”, enabling the model to process this attribute as a text input and understanding the type of responses it may need to receive from users (elicited by prompts from the LLM 162) in generating a test case. The DOM Decompiling Algorithm provides a “cleaned” and “augmented” version of DOM 340 as DOM 234 (FIG. 2A). The inventors have discovered that this ability of the DOM Decompiling Algorithm to rewrite attributes and form the cleaned and augmented DOM 234 may increase semantic significance of elements to the LLM 162 and improve processing of more accurate and efficient test cases. The DOM Decompiling Algorithm's processing continues, as depicted in FIG. 2A, with the DOM Decompiling Algorithm executing a step to analyze one or more components of the cleaned and augmented DOM 234.

### Component Identification and Classification

As illustrated in FIG. 2A, once a cleaned and augmented version of the DOM 234 has been compiled, the DOM Decompiling Algorithm proceeds to Step 236 and processes the groups of identified elements as components stored in “buckets,” depicted generally at 238A (buckets) and 238B (components) of FIG. 2A, using a classification model for each component type. In some embodiments, an exemplary classification model that may be employed by the DOM Decompiling Algorithm is a field_optionality_model, which is a bimodal classifier that considers each component, all of potential contexts of each component within a larger grouping of constructs, and determines if interacting with the component is “required.” In some embodiments, the classification model leverages interactions with the LLM (e.g., LLM 162) and the DOM Decompiling Algorithm uses a custom prompt (e.g., a prompt that inputs grouped components into the classification model) for making the classification determinations. Examples of component types include, for example, wrappers, clusters, and subroutines. The classification model organizes the identified components 238B into the buckets 238A and then workflows execute and convert the identification of components 238B into a natural language context, which is added to the prompt. As described herein, workflows are series of interactions for completing tasks associated with the identified components 238B within the DOM 234. It should be appreciated that, in some embodiments, interactions and tasks depend on a type of component and the classification received from the classification model (e.g., the field_optionality_model). Components classified as required are acted upon. For example, in some embodiments, a component type of “button” may receive an action defined as “Click,” a component type of “checkbox” may receive an action defined as “check” or “uncheck,” a component type of “text input” may receive an action defined as “fill.” It should also be appreciated that, in some embodiments, the sequencing or “workflows” are driven by component classification, model determination, and available actions. The component classifications may be used to provide inputs to the classification model (e.g., the field_optionality_model), thus prescribing interactions based on a bimodal “required” or “not-required” output.

In one embodiment, the component identification and organization process includes, for example:
1. Finding clusters within the DOM 234;
2. Finding components 238B within the DOM 234;
3. Identifying associated text or description within the components 238B of the DOM 234;
4. Grouping duplicate component types within the DOM 234 into buckets 238A; and
5. Assigning the identified components 238B to a classification model.

Once this grouping into buckets 238A of components 238B within the classification model has occurred, a modified version of the cleaned DOM 234 is generated as a Modified DOM 238. In one embodiment, the Modified DOM 238 includes the components 238B of the Cleaned DOM 234 identified and organized within the buckets 238A based on, for example, common component type. The system 100 continues execution at a next step in its processing, with the execution of the Conductor Agent Model at Step 240, to assess the interactions that should be taken on the identified and classified components 238B within the Modified DOM 238.

At Step 240, the Conductor Agent Model is executed by the test generation and execution system 100 in a test case generation stage. In one embodiment, the Conductor Agent Model includes two parts, namely, a first part illustrated at Step 242 where the Conductor Agent Model identifies a series of workflows to execute depending upon a given classification of components 238B within groupings 238A identified by the DOM Decompiling Algorithm, for example, at Step 236 where the Modified DOM 238 is created including the components 238B within the buckets 238A. In one embodiment, the workflows may include predetermined workflows 166C developed for evaluating and testing known functionality and retrieved and/or provided to the Conductor Agent Model (at Step 243) from a library of the workflows 166C within the data store 160. The output of the executed workflows are changes to the natural language prompt of the LLM 162 (e.g., a first set of simple questions, also referred to as first questions within execution of the Conductor Agent Model) to account for the classified components 238B. As noted herein, the LLM 162 is configured to use the output of the test generation and execution system 100 to generate prompts (e.g., the simple questions) to elicit responses input by the users (e.g., operators 10 of the user devices 120). In one embodiment, a second part of the Conductor Agent Model illustrated at Step 244 takes the statistically most likely command for a given classification of components 238B within the Modified DOM 238 and, for example, utilizing inference capabilities of the LLM 162, works recursively back and forth (e.g., between the Conductor Agent Model and the LLM 162) to generate potential responses and actions 245 as shown in FIG. 2A. In some embodiments, the Conductor Agent Model's inference capabilities include an ability to make predictions and/or draw conclusions from knowledge gained from the responses received to the first questions, e.g., from data received during the potential interactions of the workflows and actions on the classified components 238B. In one embodiment, the Conductor Agent Model employs browser automation tools such as, for example, an open-source software tool such as Selenium, to model a user's keyboard, mouse, and/or other input actions during the potential interactions. In one embodiment, each classification model has a preset number of options a component can take, with a singular agnostic (generalized) option if the classification model cannot determine which bucket 238A the component 238B should be allocated to. For example, by statically analyzing the component of a “calendar,” which would be represented by “input type =cal,” the Conductor Agent Model can determine that potential interactions (e.g., the responses and actions 245) may include, for example, input to move a month forward from a predetermined date, move a month backward from the predetermined date, and/or select a new date.

### Interaction Assessment & Build

As depicted at Step 244, the Conductor Agent Model takes the classified components 238B within the buckets 238A of the Modified DOM 238 and executes assigned actions. In some embodiments, execution of the assigned actions may include calls instructing software tools and/or utilities to perform the assigned action, as determined by the workflows, to the components 238B to simulate use of the software application or website by a user. Once executed, the Conductor Agent Model then analyzes the impact to the Modified DOM 238. For example, the Conductor Agent Model may determine that an impact to the Modified DOM 238 includes DOM changes or permutations, data changes and/or data updates. In some embodiments, the DOM changes or permutations may refer to any update to a visible element of the webpage under evaluation. For example, in an exemplary website providing an ability to purchase goods and/or services, an update to a visible element may include, in a shopping cart or “check out” feature, an occurrence when a customer's billing address differs from the customer's delivery address. In response to this occurrence, a series of new fields may appear on the webpage to, for example, request confirmation of the difference detected by the Conductor Agent Model. Similarly, a data change or update may refer to any update to data presented in, for example, pre-populated fields that may be impacted by actions taken by a user on the webpage under evaluation. Once again, with reference to the exemplary shopping cart or “check out” feature, an occurrence where an additional item is added to the shopping basket/cart, and the webpage/website under evaluation operates to update a total amount due to purchase the items in the shopping basket/cart.

This process of analyzing the impact to the Modified DOM 238, referred to as a recursive output check, is performed recursively by the Conductor Agent Model which allows a series of differential testing actions where a same input value is provided to a series of similar components and differences in the executed response is observed by the Conductor Agent Model. In one embodiment, the Conductor Agent Model coordinates a variety of workflows such as planning, understanding pages, classifying components, executing hard coded routines as well as acting on understood components to “learn” the identified components 238B within the buckets 238A. In one embodiment, the “learning” itself, and/or portions thereof, is a sub-workflow that may be called by the Conductor Agent Model. In this way, the Conductor Agent Model recursively generates interactions with the components 238B as well as points of observation of the functionality of the components 238B. As such, the interactions are executed and observations are recorded, e.g., stored as the responses and actions 245. In some embodiments, the response and actions 245 are stored in a temporary file maintained during execution, and in some embodiments, the response and actions 245 are stored in the data store 160 or in local memory of a user device 120 (MEM 124) or the server 150 (MEM 154). In some embodiments, the response and actions 245 are stored as the Updated DOM 248, as described below.

When the Conductor Agent Model determines that the observations made are incorrect based on, for example, expected and/or anticipated input or output for the identified component 238B, the recursive output check process resets a state of the identified component 238B and tests the validity and/or accuracy of other executed interactions. As should be appreciated, the recursive process of learning a component allows for assignment of a more reliable interaction that can be executed by the Conductor Agent Model to evaluate the functionality of the software application or website under examination. When the recursive output check is completed, questions are proposed as to what changes, if any, should be made to the Modified DOM 238 to more accurately reflect the functionality of the software application or website under evaluation. In some embodiment, an update to the Modified DOM 238 may include an addition of a proprietary mapping function, referred to as a HP Index, which maps and calculates positions of the components 238B within the DOM structure (e.g., the Modified DOM 238). In some embodiments, it has been found that by maintaining positions of the components 238B executing interactions becomes more reliable. In one embodiment, at Step 246, changes to the Modified DOM 238 are stored as an Updated DOM 248, including updates to the groups of the identified component buckets 238A now stored with the Updated DOM 248 as buckets 248A, each bucket 248A including one or more components 248B. In one embodiment, the recursive output check is similar to the process of using listener data to understand if actions can be taken on any given element, resulting in the exposure of potentially obfuscated behaviors of a given element. One goal of the recursive output check process (performed at Steps 244, 246 and 250 (discussed below)) is to ensure an initial classification of components was correct.

Once any updates to the DOM (Modified DOM 238) are stored as the Updated DOM 248, execution of the Conductor Agent Model continues from Step 246 to Step 250 following a connector labeled “A” from FIG. 2A to FIG. 2B. At Step 250, the Conductor Agent Model determines whether all the components 238B and component groupings within the buckets 238A of the Modified DOM 238 have been evaluated within the recursive output check of Step 244. If it is determined that additional components 238B and component groups with the buckets 238A should be evaluated, the Conductor Agent Model continues processing by proceeding along a “No” path from Step 250 to Step 244 following a connector labeled “B” from FIG. 2B to FIG. 2A to repeat the differential testing actions for additional components within the buckets 238A (e.g., Steps 244 and 246). When it is determined at Step 250 that no additional components 238B and component groups remain to be evaluated within the buckets 238A of the Modified DOM 238, the Conductor Agent Model continues processing by proceeding along a “Yes” path from Step 250 to Step 260 of FIG. 2B.

At Step 260, once all potential changes to the DOM (Modified DOM 238 in a first pass of the recursive output check and/or Updated DOM 248 in a second or subsequent pass of the recursive output check) have been accounted for, the Conductor Agent Model assigns the decided action to each component 248B within groupings 248A of the Updated DOM 248. With the actions of each component 248B of the subject software application or website accounted for, the Conductor Agent Model has assigned an initial set of actions to be used to evaluate the subject software application or website. For example, the Updated DOM 248 may include components 248B and assigned, initial actions (e.g., an initial set of browser automation actions such as, for example, Selenium actions) and the first questions, that may be provided/output to the LLM 162 to generate prompts (e.g., the simple questions) to elicit responses input by the users as described below with reference to the PathFinder Model tool.

At Step 270, the PathFinder Model is executed by the test generation and execution system 100 in a test case execution stage. In one embodiment, the PathFinder Model executes to ask the LLM 162 initial questions, e.g., the first set of simple questions initially from the response and actions 245 determined by the Conductor Agent Model, with respect to the identified components 248B within the Updated DOM 248 for the subject software application or website under evaluation. The PathFinder Model then compiles the responses with the component-specific, assigned actions provided from the Conductor Agent Model, as Further Response and Actions 273 as shown in FIG. 2B. For example, when filling out a “First Name” field in a user registration form, the PathFinder Model determines that an action to take is to request that a user input text with the First Name field and that the text it should expect inputted is the selected response from the simple question provided to the LLM 162 such as, for example, “Provide Examples of a First Name.”

In one embodiment, the Pathfinder Model executes two functions, described below as interaction execution and regeneration, as it determines if one or more execution “paths,” e.g., possible flows of control in a software application's or website's operation, for the test case being built accurately evaluates the functionality of the subject application or website. In some embodiments, the PathFinder Model interacts with the LLM 162 to determine the one or more execution paths. As described herein, as execution of the DOM Decompiling Algorithm (at Step 230) and Conductor Agent Model (at Step 240) by the test generation and execution system 100 reaches the PathFinder stage (at Step 270), one or more components 248B of the subject application or website have been identified and grouped in buckets 248A and an understanding is determined of what each component 248B is, such that its likely functionality is predicted (e.g., by the DOM Decompiling Algorithm), and a relevant “guess” or approximation of possible or potential actions to take on each component and a relevant sample set of data to apply to the component 248B is determined and assigned to the components 248B (e.g., by the Conductor Agent Model). With this work completed, at Step 270 the PathFinder Model interacts with the components 248B and executes the assigned actions. In some embodiments, PathFinder Model interacts with the identified components 248B and executes the assigned actions using a browser automation tool such as, for example, the aforementioned, Selenium product.

Interaction Execution

At Step 270, Pathfinder Model executes the assigned workflows and actions on the one or more identified components 248B within the buckets 248A of the Updated DOM 248 for the subject software application or website being evaluated. For example, at Step 272, PathFinder Model executes the assigned workflow and action for a first component 248B within one of the buckets 248A and, at Step 274, the PathFinder Model prompts the user to approve or deny the action taken and, for example, the input entered in execution of the assigned action. As shown in FIG. 2B, in some embodiments, the PathFinder Model interacts with the LLM 162 to prompt the user and record responses received within the Further Responses and Actions 273. Execution of the PathFinder Model continues from Step 274 to Step 276 following a connector labeled “C” from FIG. 2B to FIG. 2C. At Step 276, the Pathfinder Model determines whether the user has approved or denied the assigned action taken on the subject component 248B. When the user approves the action taken and input generated, execution of the PathFinder Model continues processing by proceeding along a “Yes” path from Step 276 to Step 278 of FIG. 2C. At Step 278, the PathFinder Model saves the user's approval and determines whether all identified components 248B within each of the identified buckets 248A have been evaluated. When the PathFinder Model determines that all identified components 248B and buckets 248A have been evaluated, processing continues by proceeding along a “Yes” path from Step 278 to Step 290 following a connector labeled “D” from FIG. 2C to FIG. 2D where execution of the PathFinder Model and the process 200, illustrated in FIGS. 2A to 2D, ends.

Referring again to Step 278 of FIG. 2C, if the PathFinder Model determines that not all identified components 248B and buckets 248A have been evaluated, processing continues by proceeding along a “No” path from Step 278 to Step 280. At Step 280, the PathFinder Model continues processing along a current execution path and train of logic underlying the same by retrieving a next component 248B or next bucket 248A of the Updated DOM 248 for evaluation. Execution of the PathFinder Model continues from Step 280 to Step 272 following a connector labeled “E” from FIG. 2C to FIG. 2B to repeat execution of Steps 272, 274, and 276, for an assigned action of the next component 248B within one of the buckets 248A.

Referring again to Step 276 of FIG. 2C, if it is determined that the assigned action for the current component 248B is not acceptable, for example, the PathFinder Model uncovers an incorrect assertion or incorrect data entered and/or the user denies or does not approve the action taken and/or input generated, execution of the PathFinder Model continues processing by proceeding along a “No” path from Step 276 to Step 282 of FIG. 2C, where the PathFinder Model executes a regeneration function, described below.

Recursive Event Determination Model

At Step 282, the regeneration process utilizes a recursive event determination model to re-identify the components of the Modified DOM 238 and/or Updated DOM 248 including the initially identified components 238B/248B and groupings or buckets 238A/248A therefor. In one embodiment, the recursive event determination model may re-identify one or more components 248B of the Updated DOM 248, re-group one or more components 248B in current buckets 248A or define new buckets 248A, and/or re-assess interactions with one or more components 248B as determined by the Conductor Agent Model having now received a response from a user. Execution of the PathFinder Model continues from Step 282 to Step 284 following a connector labeled “F” from FIG. 2C to FIG. 2D. At Step 284 of FIG. 2D, execution of the PathFinder Model continues as actions are assigned to reflect the changes associated with the re-identified components 248B, re-grouped or new buckets 248A, and re-assessed interactions of the components 248B by the PathFinder Model in its execution of the regeneration process, now stored in a Regenerated DOM 286, including buckets 286A and components 286B, in accordance with one embodiment. With the revised actions of each component 286B of the subject software application or website accounted for, the PathFinder Model has reassigned the initial set of actions (e.g., determined by the Conductor Agent Model at Step 260) to improve the evaluation of the subject application or website. Accordingly, the Regenerated DOM 286 may be provided/output to the LLM 162 to generate new prompts (e.g., simple questions) to elicit further responses input by the users and continue to refine the test case being built to evaluate the subject application and/or website. Once the results of the regeneration processed are stored in the Regenerated DOM 286, execution of the PathFinder Model continues from Step 284 to Step 274 following a connector labeled “G” from FIG. 2D to FIG. 2B to repeat execution of Steps 274, 276, and 278, for the assigned actions of the regenerated component 286B within the buckets 286A of the Regenerated DOM 286. It should be appreciated that once the regeneration process is completed, the Regenerated DOM 286 including the buckets 286A and components 286B thereof, are evaluated at Steps 274, 276, and 278, and a second or later generation of the Regenerated DOM 286 may be created at Step 284.

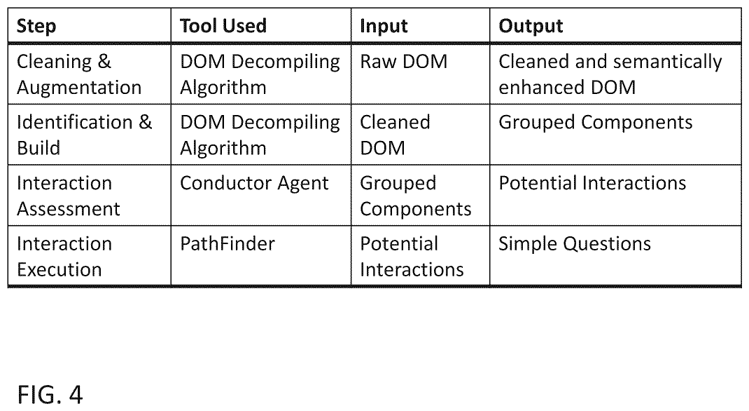

As should be appreciated, the test generation and execution system 100 executes the three (3) tools including the DOM Decompiling Algorithm (Step 230), the Conductor Agent Model (Step 240), and the PathFinder Model (Step 270) to build a test case to evaluate the subject software application and/or website. As shown in FIG. 4, a table is provided depicting, at a high level, the input and output of the tools in accordance with one embodiment of the present disclosure. It should also be appreciated that one of more of the Raw DOM, the Cleaned DOM 234, the Modified DOM 238, the Updated DOM 248, and/or the Regenerated DOM 286 may be stored in the internal memories 124 and 154 of the user devices 120 or server 150, and/or the networked memory of, for example, the data storage device 160 and/or the data storage devices 194.

It should be appreciated that the phraseology and the terminology used in the description of the various embodiments described herein should be given their broadest interpretation and meaning as the purpose is for describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, and equivalents thereof, and do not preclude the presence or addition of one or more other features, integers, steps, operations, elements, components, groups and/or equivalents thereof.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for automated generation and execution of test cases to evaluate performance of at least one of a computer-implemented software application or a website, the system comprising:
a processor;
a memory operatively coupled to the processor and storing instructions that, when executed by the processor, cause the system to:
receive a document object model (DOM) of the at least one the computer-implemented software application or the website;
identify interactable elements within the DOM;
classify the identified elements into one or more components;
identify workflows and actions to determine potential interactions with a user for completing tasks associated with the classified one or more components;
execute the identified workflows and actions to generate first questions to guide the potential interactions between the user and each of the classified one or more components, and receive responses to the first questions;
recursively assess the received responses to the first questions generated from the executed workflows and actions for the potential interactions for each of the one or more components, determine acceptability of the received responses, and wherein when the received responses are determined to be incorrect, regenerate the first questions, the workflows and the actions to guide next potential interactions for each of the classified one or more components and re-execute the re-generated workflows and actions, and wherein when the received responses for each of the one or more components are determined to be correct, assign the first questions, the workflows, and the actions determined to be correct to a corresponding one of the one or more components, wherein the assigned first questions are defined as simple questions;
execute the assigned workflows and actions as interactions of the user with the one or more components, prompt the user with the simple questions and request the user approve the executed actions and input provided during execution, and receive responses input by the user;
recursively assess the received user responses to each of the executed actions for the one or more components, wherein when a response is indicative of a user determined unacceptable interaction, regenerate the identified workflows, actions, and simple questions to guide a next interaction with each of the classified one or more components and present the regenerated simple questions to the user and receive the responses input by the user, and wherein when the response is indicative of a user determined acceptable interaction, assign the identified workflows, actions, and simple questions for evaluating the performance of the classified one or more components; and
wherein when all the classified one or more components are assessed, store the assigned workflows, actions, and simple questions for each of the classified one or more components as a test case for evaluating the functionality of the at least one computer-implemented software application or the website including the one or more components.

2. The system of claim 1, wherein the instructions further cause the system to:
prior to identifying the interactable elements within the DOM, determine test objectives and performance metrics for the at least one of the computer-implemented software application or the website being evaluated, the test objectives including pretext information and context information.

3. The system of claim 2, wherein the pretext information defines a purpose of functionality within the at least one of the computer-implemented software application or the website being evaluated.

4. The system of claim 3, wherein the pretext information further includes a persona for presenting the simple questions to the user.

5. The system of claim 2, wherein the context information defines a background of the functionality within the at least one of the computer-implemented software application or the website being evaluated.

6. The system of claim 1, wherein the instructions to identify the interactable elements within the DOM further include instructions that, when executed by the processor, cause the system to:
decompile the DOM into elements thereof;
evaluate the elements of the decompiled DOM and identify useful elements and un-useful elements within the decompiled DOM, the useful elements including the interactable elements; and
generate a cleaned DOM by removing the un-useful elements and maintaining the useful elements of the decompiled DOM.

7. The system of claim 6, wherein the un-useful elements are static elements within the DOM and the interactable elements are elements of the DOM including at least one of executable functionality or a link to another element or other content of the DOM.

8. The system of claim 6, wherein prior to the instructions to cause the system to generate the cleaned DOM, the instructions further cause the system to:
augment the useful elements with listener data to detect an impact of functionality of the useful elements to further identify interactable elements within the useful elements.

9. The system of claim 1, wherein the instructions to classify the identified elements include instructions that, when executed by the processor, cause the system to:
classify the identified elements as the one or more components based on a classification model; and
generate a modified DOM including the classified and semantically enhanced one or more components.

10. The system of claim 9, wherein the instructions to classify the identified elements further include instructions that, when executed by the processor, cause the system to:
assign the one or more components into buckets based upon predetermined rules and associated workflows for the one or more components, wherein two or more components of a same type are assigned to a same bucket.

11. The system of claim 1, wherein the instructions to identify workflows and action further include instructions that, when executed by the processor, cause the system to:
retrieve the workflows from a library of workflows associated with a type of the component.

12. The system of claim 1, wherein the instructions to recursively assess the potential interactions for each of the one or more components further include instructions that, when executed by the processor, cause the system to:
interact with a large language model (LLM) to at least one of determine whether the received responses are correct or determine the re-generated workflows and actions to be executed.

13. The system of claim 12, wherein the instructions to interact with the LLM to determine the re-generated workflows and actions further include instructions that, when executed by the processor, cause the system to:
determine statistically by utilizing an inference capability of the LLM the interaction for a classification of the one or more components to define the re-generated workflows and actions.

14. The system of claim 1, wherein the instructions to assign the questions, the workflows and the actions are determined to be correct further include instructions that, when executed by the processor, cause the system to:
generate an updated DOM including the assigned workflows, the actions, and the questions for each of the corresponding ones of the one or more components.

15. The system of claim 1, wherein the instructions to prompt the user to approve the executed actions further include instructions that, when executed by the processor, cause the system to:
generate a natural language prompt for a large language model (LLM) to present to the user as a prompt to elicit the response from the user.

16. The system of claim 1, wherein the instructions to regenerate the identified simple questions, the workflows and the actions further include instructions that, when executed by the processor, cause the system to:
generate a regenerated DOM including the assigned workflows, the actions, and the simple questions for each of the corresponding ones of the one or more components.

17. A method for an automated generation and execution of test cases to evaluate performance of at least one of a computer-implemented software application or a website, the method comprising:
receiving a document object model (DOM) of the at least one the computer-implemented software application or the website;
identifying interactable elements within the DOM;
classifying the identified elements into one or more components;
identifying workflows and actions to determine potential user interactions for completing tasks associated with the classified one or more components;
executing the identified workflows and actions to generate first questions to guide the potential interactions between the user and each of the classified one or more components, and receiving responses to the first questions;
recursively assessing the received responses to the first questions generated from the executed workflows and actions for the potential interactions for each of the one or more components, determining acceptability of the received responses, and wherein when the received responses are determined to be incorrect, regenerating the first questions, the workflows, and actions to guide next potential interactions for each of the classified one or more components and re-executing the regenerated workflows and actions, and wherein when the received responses for each of the one or more components are determined to be correct, assigning the first questions, the workflows, and the actions determined to be correct to a corresponding one of the one or more components;
executing the assigned workflows and actions as interactions of the user with the one or more components, prompting the user with the simple questions and requesting the user approve the executed actions and input provided during execution, and receiving responses input by the user;
recursively assessing the received user responses to each of the executed actions for the one or more components, wherein when a response is indicative of a user determined unacceptable interaction, regenerating the identified workflows, actions, and simple questions to guide a next interaction with each of the classified one or more components and presenting the regenerated simple questions to the user and receiving the responses input by the user, and wherein when the response is indicative of a user determined acceptable interaction, assigning the identified workflows, actions, and simple questions for evaluating the performance of the classified one or more components; and
wherein when all the classified one or more components are assessed, storing the assigned workflows, actions, and simple questions for each of the classified one or more components as a test case for evaluating the functionality of the at least one computer-implemented software application or the website including the one or more components.

18. The method of claim 17, wherein prior to identifying the interactable elements within the DOM, the method further includes:
determining test objectives and performance metrics for the at least one of the computer-implemented software application or the website being evaluated, the test objectives including pretext information and context information.

19. The method of claim 17, wherein identifying the interactable elements within the DOM further includes:
decompiling the DOM into elements thereof;
evaluating the elements of the decompiled DOM and identifying useful elements and un-useful elements within the decompiled DOM, the useful elements including the interactable elements; and
generating a cleaned DOM by removing the un-useful elements and maintaining the useful elements of the decompiled DOM.

20. The method of claim 17, wherein the recursively assessing the potential interactions for each of the one or more components further includes:
interacting with a large language model (LLM) to at least one of determine whether the received responses are correct or determine the next workflows and the next actions to be executed.

21. The method of claim 20, wherein the interacting with the LLM to determine the next workflows and the new actions further includes:
utilizing an inference capability of the LLM to statistically determine the next workflow and next action.

22. The method of claim 17, wherein the prompting of the user to approve the executed actions further includes:
generating a natural language prompt for a large language model (LLM) to present to the user as the prompt to elicit the response from the user.

23. A system for automated generation of test cases to evaluate performance of at least one of a computer-implemented software application or a website, the system comprising:
a processor;
a memory operatively coupled to the processor and storing instructions that, when executed by the processor, cause the system to:
receive a document object model (DOM) of the at least one the computer-implemented software application or the website;
determine test objectives and performance metrics for the at least one of the computer-implemented software application or the website, the test objectives including pretext information and context information;
decompile the DOM into elements thereof;
evaluate the elements of the decompiled DOM and identify useful elements and un-useful elements within the decompiled DOM, the useful elements including identified interactable elements;
generate a cleaned DOM by removing un-useful elements and maintaining the useful elements from the decompiled DOM;
classify the identified interactable elements of the cleaned DOM into components and buckets of similar components based on a classification model and rules including a type of functionality initiated by the components;
generate a modified DOM from the cleaned DOM, the modified DOM including the classified and semantically enhanced components;
identify workflows and actions to determine potential interactions with a user for completing tasks associated with the components of the modified DOM;
execute the identified workflows and actions to generate first questions to guide the potential interactions between the user and each of the classified one or more components, and receive responses to the first questions;
recursively assess the received responses to the first questions generated from the executed workflows and actions for the potential interactions for each of the one or more components by interacting with a large language model (LLM), determine acceptability of the received responses, and wherein when the received responses are determined to be incorrect, regenerate the first questions, the workflows and actions to guide next potential interactions for each of the classified one or more components and re-execute the regenerated workflows and the next actions, and wherein when the received responses for each of the one or more components are determined to be correct, assign the first questions, the workflows, and the actions determined to be correct to a corresponding one of the one or more components, wherein the LLM utilizes an inference capability to regenerate the first questions, the workflows and actions, and wherein the first questions are defined as simple questions;
execute the assigned workflows and actions as interactions of the user with the one or more components, prompt the user with the simple questions and request the user approve the executed actions and input provided during execution, and receive responses input by the user;
recursively assess the received user responses to each of the executed actions for the one or more components, wherein when a response is indicative of a user determined unacceptable interaction, regenerate the identified workflows, actions, and simple questions to guide a next interaction with each of the classified one or more components and present the regenerated simple questions to the user and receive the responses input by the user, and wherein when the response is indicative of a user determined acceptable interaction, assign the identified workflows, actions, and simple questions for evaluating the performance of the classified one or more components; and
wherein when all the classified one or more components are assessed, store the assigned workflows, actions, and simple questions for each of the classified one or more components as a test case for evaluating the functionality of the at least one computer-implemented software application or the website including the one or more components.
